(19) United States
(12) Patent Application Publication
(10) Pub. No.: US 2020/0241988 A1
(43) Pub. Date: Jul. 30, 2020

(54) INFORMATION PROCESSING APPARATUS, METHOD, AND COMPUTER PROGRAM PRODUCT

(71) Applicant: FUJITSU CLIENT COMPUTING LIMITED, Kanagawa (JP)

(72) Inventor: Kazuyoshi Toya, Kawasaki (JP)

(73) Assignee: FUJITSU CLIENT COMPUTING LIMITED, Kanagawa (JP)

(21) Appl. No.: 16/712,312

(22) Filed: Dec. 12, 2019

(30) Foreign Application Priority Data
Jan. 30, 2019 (JP) 2019-014584

(51) Int. Cl. G06F 11/30; G06F 11/32; G06F 8/65; G06F 9/48

(52) U.S. Cl. CPC G06F 11/3024; G06F 9/485; G06F 8/65; G06F 11/324

(57) ABSTRACT

An information processing apparatus includes: a plurality of control processing devices and a plurality of information processing devices. The control processing devices control operations compatibly with each other. The information processing devices perform various types of information processing through an interface shared by the control processing devices under control of any of the control processing devices. Before a first control processing device, which controls the information processing devices, is switched to a second control processing device among the control processing device, the second control processing device is set as a copy of the first control processing device. The information processing devices are sequentially switched to be controlled by the second control processing device in a period where the information processing devices do not execute tasks constituting the information processing.

### CROSS-REFERENCE TO RELATED APPLICATIONS

This application is based upon and claims the benefit of priority from Japanese Patent Application No. 2019-014584, filed Jan. 30, 2019, the entire contents of which are incorporated herein by reference.

### FIELD

Embodiments described herein relate to an information processing device, a method, and a computer program product.

### BACKGROUND

In recent years, personal computers (hereinafter, “PCs”) have been improved in performance, each being provided with a plurality of central processing unit (CPU) cores mounted on a microprocessor unit (MPU). The PCs are capable of being provided with sufficient amounts of memories and storages even at a low cost, so that opportunities have increased to perform processing, such as deep learning and machine learning, on each of the PCs. In addition to the use in such processing, the PCs have been utilized for scientific measurement applications since a long time ago and have become to be used for processing to externally load a larger amount of seamless data than in cases of originally assumed office processing applications, such as document creation and spreadsheet calculation.

While a large amount of data is required to be handled, it is needed to apply a security patch to an operating system (OS) at an appropriate time as early as possible in order to maintain and protect confidential data from external attacks on windows of vulnerability of the OS and various types of software.

By taking a security measure at an appropriate time in this way, the data to be handled can be protected from the threats.

In a case where the PC is suddenly restarted due to action of the OS during processing in which large amount of data externally flowing into the PC is continued to be received and processed, a problem arises such that the processing is interrupted or becomes incomplete state and it takes time for reprocessing.

For preventing the interruption for maintenance, there is a method of entrusting the maintenance to a virtual computer on a cloud computing server. However, the maintenance cannot sometimes be entrusted due to a problem of, for example, a law, maintenance cost, data transfer time, or mismatch with terms of service of a cloud service provider.

### SUMMARY

An information processing apparatus according to an embodiment includes: a plurality of control processing devices and a plurality of information processing devices. The control processing devices are configured to be capable of performing control operations compatibly with each other. The information processing devices are configured to perform various types of information processing through an interface shared by the control processing devices under control of any of the control processing devices. Before a first control processing device, which controls the information processing devices, is switched to a second control processing device among the control processing device, the second control processing device is configured as (i.e., is set as) a copy of the first control processing device. The information processing devices are sequentially switched to being under control of the second control processing device in a period where the information processing devices do not execute tasks constituting the information processing.

### BRIEF DESCRIPTION OF THE DRAWINGS

FIG. 1 is a block diagram of a schematic configuration of an information processing apparatus according to an embodiment of the present disclosure;

FIG. 2 is a processing flowchart during maintenance on a main system 11M (a main OS) side;

FIG. 3 is a processing flowchart during the maintenance on a subsystem 11S (a sub-OS) side;

FIG. 4 is an operation sequence diagram (Part 1) of components during the maintenance of the information processing apparatus; and

FIG. 5 is an operation sequence diagram (Part 2) of the components during the maintenance of the information processing apparatus.

### DETAILED DESCRIPTION

The following describes an embodiment of the information processing apparatus according to the present disclosure with reference to the drawings. The embodiment described below is merely an example, and is not intended to exclude applications of various modifications or techniques not explicitly described in the embodiment. In other words, the present embodiment can be implemented by being variously modified within a scope not deviating from the gist thereof. The drawings are not intended to include only components illustrated therein, and can include, for example, other functions.

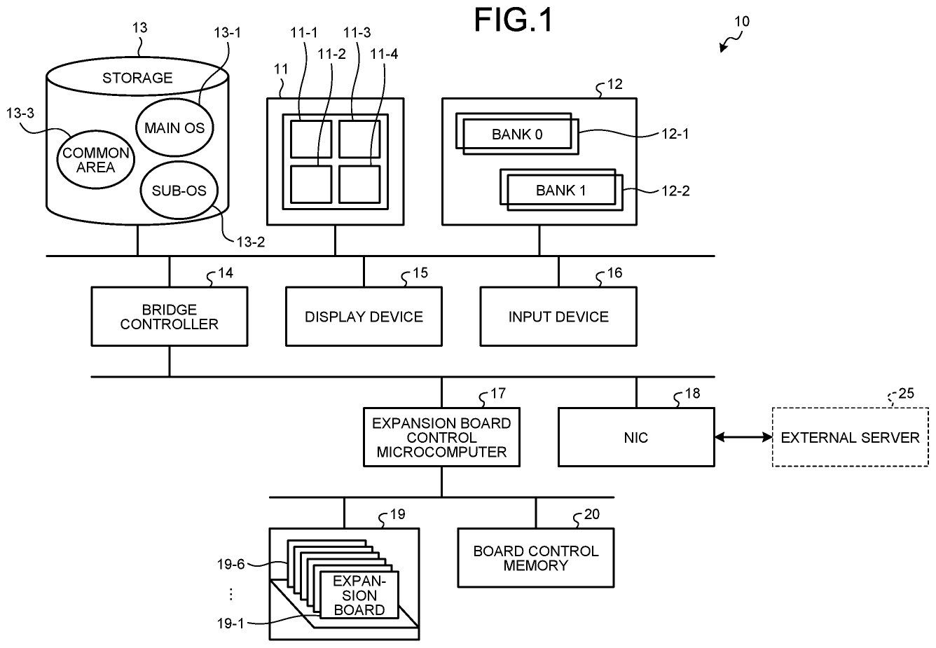

FIG. 1 is a block diagram of a schematic configuration of the information processing apparatus according to the embodiment.

An information processing apparatus 10 includes, in a broad sense, an MPU 11, a memory module 12, a storage 13, a bridge controller 14, a display device 15, an input device 16, an expansion board control microcomputer 17, a network interface controller (NIC) 18, an expansion board unit 19, and an (expansion) board control memory 20.

The MPU 11 includes a plurality of (four in FIG. 1) CPU cores 11-1 to 11-4 (the plurality of control processing devices). In addition, a main operating system (main OS) and a sub-operating system (sub-OS) are assigned to the MPU 11, and are operable. For example, the main OS is installed on the CPU cores 11-1 and 11-2, and the sub-OS is installed on the CPU cores 11-3 and 11-4.

The memory module 12 is configured as a semiconductor memory and includes two memory banks 12-1 and 12-2. The first memory bank 12-1 (denoted as “bank 0” in FIG. 1) is assigned to the main OS. The second memory bank 12-2 (denoted as “bank 1” in FIG. 1) is assigned to the sub-OS.

The storage 13 (a storage device) is configured as, for example, a hard disk drive or a solid-state drive (SSD), and includes an area 13-1 for the main OS, an area 13-2 for the sub-OS, and a common area commonly used by the main OS and the sub-OS.

The bridge controller 14 (the interface) is configured as, for example, a Peripheral Component Interconnect Express (PCI-e) bridge controller, and controls various types of communication with the expansion board unit 19 under the control of the MPU 11.

The display device 15 is configured as, for example, a liquid crystal display, and displays various types of information.

The input device 16 is configured as, for example, a keyboard, a mouse, a voice input device, and/or various sensors, and receives, for example, various types of data.

The expansion board control microcomputer 17 performs operation control, for example, cooperative operation control on a plurality of (six in FIG. 1) expansion boards 19-1 to 19-6 (the plurality of information processing devices), which are provided with coprocessors and constitute the expansion board unit 19.

The network interface controller (NIC) 18 connects the information processing apparatus 10 to an external server 25 so that the connected ones can communicate with each other through a communication network (such as the Internet), which is not illustrated.

The expansion board unit 19 performs, by the expansion boards 19-1 to 19-6, distributed processing such as inference processing, for example.

The board control memory 20 stores various types of data used by the expansion board control microcomputer 17 for controlling the operation of the expansion board unit 19.

The following describes operations of the embodiment by way of exemplary operations during an update on the operating system in each of a main system 11M and a subsystem 11S.

In the present embodiment, between the main system and the subsystem, the main system 11M (main system OS side) performs normal processing, and the subsystem 11S (subsystem OS side) is in a standby state. The subsystem 115 does not perform processing during a normal state. Thus, the description will be made on an assumption that, even if a change is made on the main system 11M, such as an update on application software or a change in registry settings or various settings, the change is not applied to the subsystem 115 at the time when such change is made.

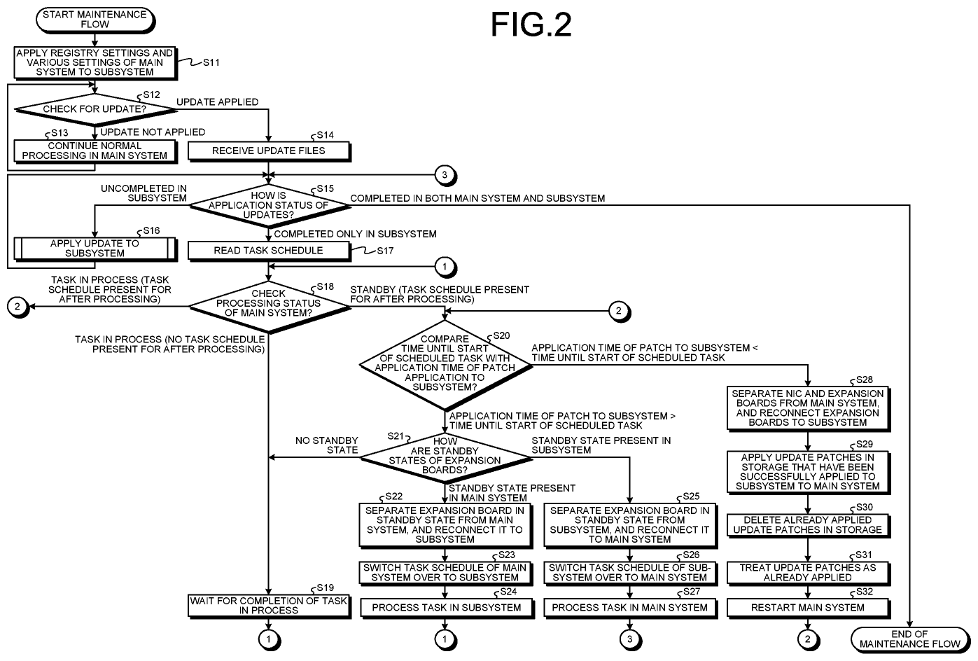

FIG. 2 is a processing flowchart during maintenance on the main system 11M (main OS) side.

The main system 11M (CPU cores 11-1 and 11-2 side) notifies the subsystem OS side of the registry settings of the main system to apply the registry settings thereof as registry settings of the subsystem 11S (subsystem OS) (Step S11).

Through the network interface controller 18 and the communication network (not illustrated), the main system 11M inquires of the external server 25, which manages an update on the OS, whether there is an update to be applied (Step S12).

In Step S12, when there is no update to be applied, the main system 11M continues the normal processing (Step S13) and repeats the processing from Step S12.

In Step S12, when there is the update to be applied, the main system 11M receives update files from the external server 25 managing the update on the OS through the communication network (not illustrated) and the network interface controller 18, and stores the update files in a common area 13-3 of the storage 13 (Step S14).

The main system 11M determines an application status of the updates on the main system 11M and the subsystem 11S (Step S15).

In the present embodiment, before the update on the OS of the main system 11M, the update on the OS of the subsystem 11S is performed and a determination is made as to whether a patch file is applicable. Then, a patch file that has not been applied (that is not to be applied) to the update on the OS of the subsystem 11S is not applied to the update on the OS of the main system 11M.

Hence, in the determination at Step S15, when the update on the subsystem 11S is uncompleted (uncompleted in subsystem at Step S15), the update is applied to the subsystem 11S (Step S16).

The following describes the update to the subsystem 11S performed at Step S16.

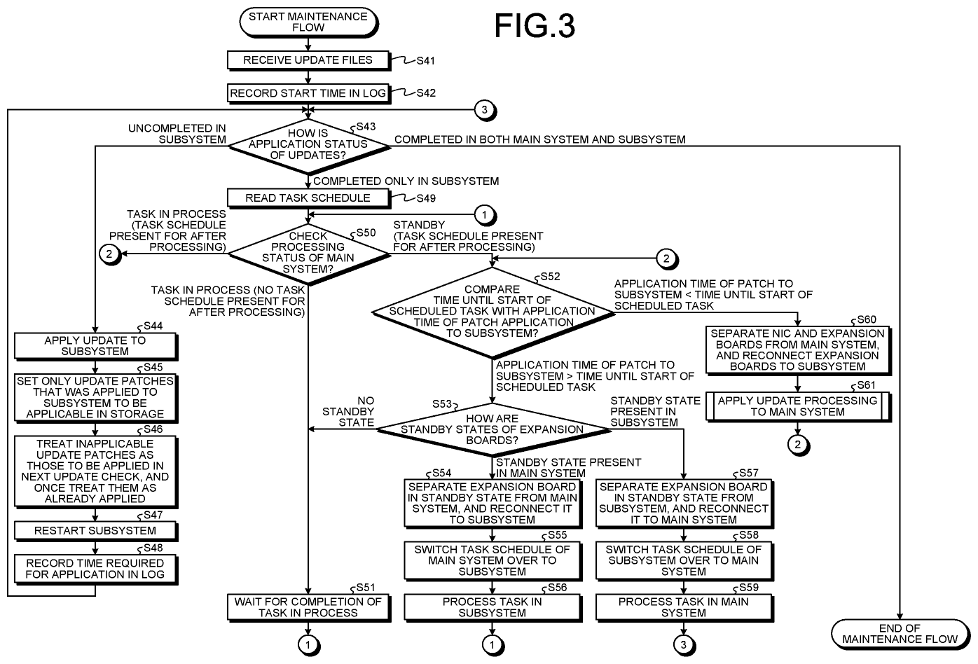

FIG. 3 is a processing flowchart during the maintenance on the subsystem 11S (sub-OS) side.

The subsystem 11S receives the update files from the common area 13-3 of the storage 13 (Step S41).

The subsystem 11S records a start time of the update processing on a log provided in the common area 13-3 of the storage 13 (Step S42).

Subsequently, the subsystem 11S determines the application status of the updates on the main system 11M and the subsystem 11S (Step S43).

In the determination at Step S43, when the update on the subsystem 11S is uncompleted (uncompleted in subsystem at Step S43), the update is actually applied to the subsystem 11S (Step S44). In other words, the update processing is performed on the subsystem 11S to update the subsystem 11S (sub-OS).

The subsystem 11S sets only update patch files among the received update files, which have been actually applied to the subsystem 11S, to be valid on the storage 13 (Step S45).

In addition, the subsystem 115 treats update patch files, which have failed to be applied to the subsystem 115, as those to be applied in the next update check, and temporarily treats them as already applied (Step S46).

Then, the subsystem 11S is restarted (Step S47). Even in this state, the main system 11M continues the normal operation. Only the CPU cores 11-3 and 11-4 on the subsystem OS side are restarted (cold-started).

The application time of (time required for) the update processing is recorded in the log provided in the common area 13-3 of the storage 13 (Step S48). The processing is returned to Step S43 and is continued.

As a result, the determination at Step S43 is made to be a case where only the update on the subsystem 11S is completed (completed only in subsystem at Step S43). Then, a task schedule of the main system 11M is read out (Step S49).

The subsystem 11S checks the processing status of the main system with reference to the task schedule (Step S50).

In the check of the processing status at Step S50, when the main system 11M is in process of a task and no other task has been scheduled after the end of the process of the task (task in process [no task schedule present for after processing] at Step S50), the subsystem 11S waits until the scheduled task is completed (Step S51). After the wait, the processing is returned to Step S50 to check the processing status.

In the check of the processing status at Step S50, when the main system 11M is in process of a task and another task has been scheduled after the end of the process of the task (task in process [task schedule present for after processing] at Step S50), or, when the main system 11M is in the standby state and another task has been scheduled after the end of the process of the task (standby [task schedule present for after processing] at Step S50), the subsystem 11S compares the time until the start of the next scheduled task with the application time of the update patch to the subsystem 11S (Step S52).

In the comparison at Step S52, when the condition of “the application time of the update patch to the subsystem 11S>the time until the start of the next scheduled task” is satisfied, the subsystem 11S determines standby states of the expansion boards 19-1 to 19-6 through the bridge controller 14 and the expansion board control microcomputer 17 (Step S53).

In the determination at Step S53, when none of the expansion boards 19-1 to 19-6 is in the standby state in both the main system 11M and the subsystem 11S (no standby state at Step S53), the subsystem 11S waits for completion of the task in process (Step S51). After the wait, the processing is returned to Step S50.

In the determination at Step S53, when any of the expansion boards 19-1 to 19-6 is in the standby state in the main system 11M (standby state present in main system at Step S53), the bridge controller 14 logically separates a control system of the expansion board in the standby state from the main system 11M and reconnects the control system to the subsystem 11S (Step S54).

Next, a subsequent task schedule of the main system 11M is switched over (assigned to) the subsystem 11S (Step S55), and the corresponding tasks are processed by the subsystem 11S (Step S56).

Then, the processing is returned to Step S50.

In the determination at Step S53, when any of the expansion boards 19-1 to 19-6 is in the standby state in the subsystem 11S (standby state present in subsystem at Step S53), the bridge controller 14 logically separates the control system of the expansion board in the standby state from the subsystem 11S and reconnects the control system to the main system 11M (Step S57).

Next, a subsequent task schedule of the subsystem 11S is switched over (assigned to) the main system 11M (Step S58), and the corresponding tasks are processed by the main system 11M (Step S59).

Then, the processing is returned to Step S43.

In the comparison at Step S52, when the condition of “the application time of the update patch to the subsystem 11S <the time until the start of the next scheduled task” is satisfied, the network interface controller 18 and the control systems of the expansion boards 19-1 to 19-6 are separated from the main system 11M, and the bridge controller 14 reconnects the control systems of the expansion boards 19-1 to 19-6 to the subsystem 11S (Step S60).

Then, the update processing is applied to the main system 11M (Step S61).

The following description is made with referring again to FIG. 2.

On reaching this state, the subsystem 11S can perform the normal processing in place of the main system 11M.

In the determination at Step S15, the update has been applied to only the subsystem 11S (completed only in subsystem at Step S15). Thus, the main system 11M reads the task schedule (Step S17).

The main system 11M checks the processing status of the main system 11M (Step S18).

In the check of the processing status at Step S18, when the main system 11M is in process of a task and no other task has been scheduled after the end of the process of the task (task in process [no task schedule present for after processing] at Step S18), the subsystem 11S waits until the scheduled task is completed (Step S19). After the wait, the processing is returned to Step S18 to check the processing status.

In the check of the processing status at Step S18, when the main system 11M is in process of a task and another task has been scheduled after the end of the process of the task (task in process [task schedule present for after processing] at Step S18), or, when the main system 11M is in the standby state and another task has been scheduled after the end of the process of the task (standby [task schedule present for after processing] at Step S18), the main system 11M compares the time until the start of the next scheduled task with the application time of the update patch to the subsystem 11S (Step S20).

In the comparison at Step S20, when the condition of “the application time of the update patch to the subsystem 11S >the time until the start of the next scheduled task” is satisfied, the main system 11M determines the standby states of the expansion boards 19-1 to 19-6 through the bridge controller 14 and the expansion board control microcomputer 17 (Step S21).

In the determination at Step S21, when none of the expansion boards 19-1 to 19-6 is in the standby state in both the main system 11M and the subsystem 11S (no standby state at Step S21), the main system 11M waits for completion of the task in process (Step S19). After the wait, the processing is returned to Step S18.

In the determination at Step S21, when any of the expansion boards 19-1 to 19-6 is in the standby state in the main system 11M (standby state present in main system at Step S21), the bridge controller 14 logically separates the control system of the expansion board in the standby state from the main system 11M and reconnects the control system to the subsystem 11S (Step S22).

Next, a subsequent task schedule of the main system 11M is switched over (assigned to) the subsystem 11S (Step S23), and the corresponding tasks are processed in the subsystem 11S (Step S24).

Then, the processing is returned to Step S18.

In the determination at Step S21, when any of the expansion boards 19-1 to 19-6 is in the standby state in the subsystem 11S (standby state present in subsystem at Step S21), the bridge controller 14 logically separates the control system of the expansion board in the standby state from the subsystem 11S and reconnects the control system to the main system 11M (Step S25).

Next, a subsequent task schedule of the subsystem 11S is switched over (assigned to) the main system 11M (Step S26), and the corresponding tasks are processed in the main system 11M (Step S27).

Then, the processing is returned to Step S15.

In the comparison at Step S20, when the condition of “the application time of the update patch to the subsystem 11S <the time until the start of the next scheduled task” is satisfied, the network interface controller 18 and the control systems of the expansion boards 19-1 to 19-6 are separated from the main system 11M, and the bridge controller 14 reconnects the control systems of the expansion boards 19-1 to 19-6 to the subsystem 11S (Step S28).

Only the update patch files stored in the common area 13-3 of the storage 13, which have been applied to the subsystem 11S, are used to perform the update processing and the application thereof to the main system 11M (Step S29).

Next, the already applied update patch files stored in the common area 13-3 of the storage 13 are deleted (Step S30).

The update patch files are handled as already applied (Step S31), and only the main system 11M is restarted (Step S32). Then, the processing is returned to Step S20.

On reaching this state, the main system 11M that has been updated can perform the normal processing in place of the subsystem 11S.

The main system 11M compares the time until the start of the next scheduled task with the application time of the update patch to the subsystem 11S (Step S20).

In the comparison at Step S20, when the condition of “the application time of the update patch to the subsystem 11S>the time until the start of the next scheduled task” is satisfied, and in the determination at Step S21, when any of the expansion boards 19-1 to 19-6 is in the standby state in the subsystem 11S (standby state present in subsystem at Step S21), the bridge controller 14 logically separates the control system of the expansion board in the standby state from the subsystem 11S and reconnects the control system to the main system 11M (Step S25).

Then, a subsequent task schedule of the subsystem 11S is switched over (assigned to) the main system 11M (Step S26), and the corresponding tasks are processed in the main system 11M (Step S27).

Then, the processing is returned to Step S15.

As a result, in the determination at Step S15, it is determined that the update have been applied to the main system 11M and the subsystem 11S (completed in both main system and subsystem at Step S15), so that the update processing is completed, and the maintenance processing ends. After that, processing shifts to the normal processing.

As described above, according to the present embodiment, when the OS is updated in the maintenance of the information processing apparatus 10, the update is first applied to the subsystem 11S alone, and after that, the main system 11M is updated by using only update patch files that have been successfully applied to update the subsystem 11S. Therefore, in comparison with a case of updating the main system 11M from the start, more reliable update processing can be performed. In addition, time can also be reduced for trying to apply the update patch files that failed to be applied, and the maintenance (OS update) can be performed more reliably and in a shorter time.

The following mainly describes operations of components during the maintenance of the information processing apparatus 10.

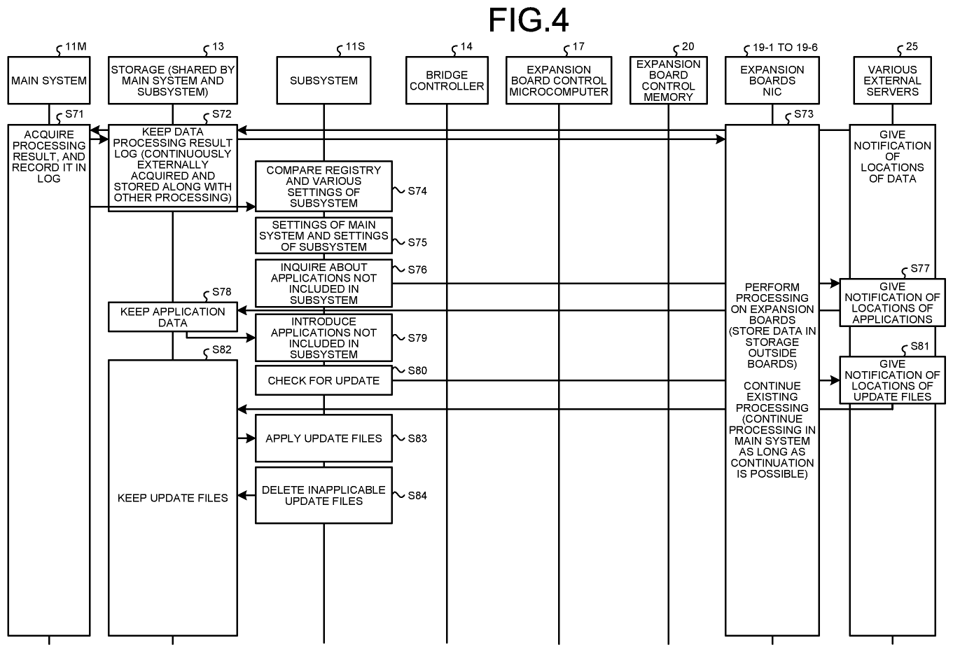

FIG. 4 is an operation sequence diagram (Part 1) of the components during the maintenance of the information processing apparatus.

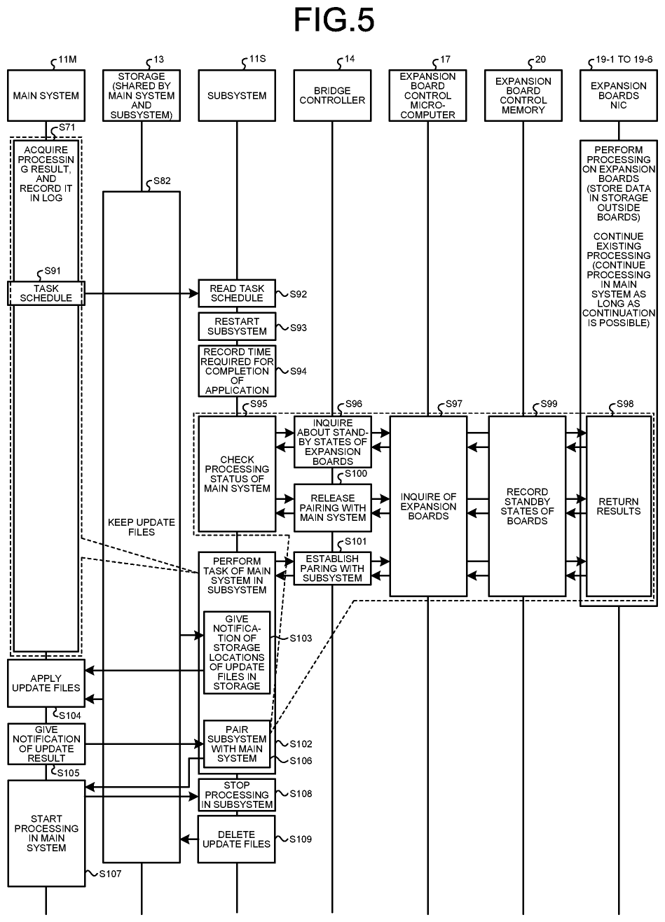

FIG. 5 is an operation sequence diagram (Part 2) of the components during the maintenance of the information processing apparatus.

First, as illustrated in FIG. 4, the main system 11M acquires a processing result (Step S71) and records it in the log in the storage 13 (Step S72).

At this time, the network interface controller 18 stores various types of data in process in the storage 13. Even in the maintenance, the network interface controller 18 continues to perform processing in the main system 11M as long as the existing processing can be continued (Step S73).

In this state of the maintenance, when the OS update is instructed, the subsystem 11S compares registry settings and various settings thereof with the registry settings and the various settings of the main system 11M (Step S74).

The subsystem 11S refers to the registry settings and the various settings of the main system 11M, and sets the settings of the subsystem 11S to have the same values as those of the settings of the main system 11M (Step S75).

The subsystem 11S inquires of an external server 25 corresponding to application software, which is not present in the subsystem 11S, whether the application is present (Step S76). In response to the inquiry, the external server 25 gives a notification of a storage location of the application software (Step S77).

Data of the application software (application data) is stored and hold in the storage 13 (Step S78).

The subsystem 11S introduces the application software that has not been introduced (installed) in this subsystem 11S (Step S79).

At this stage, the subsystem 11S has the same configuration as that of the main system except the update status of the operating system.

Then, the subsystem 11S inquires of an external server 25 managing the update (this external server 25 may be the same as or different from the external server 25 that has been given the inquiry at Step S76) whether an update on the operating system is present (Step S80).

When the update to be applied to the operating system is present, the external server 25 gives a notification of locations of update patch files (Step S81).

As a result, the update patch files for the operating system are stored and hold in the storage 13 (Step S82).

Subsequently, the subsystem 11S applies the update patch files to perform the update (Step S83).

When update patch files, which were failed to be applied (were inapplicable) when the update is performed, are present in the hold update files, the inapplicable update patch files are deleted from the storage 13 so as not to be tried to be applied to the main system 11M (Step S84).

The subsystem 11S causes the main system 11M to output the task schedule (Step S91) and reads the task schedule (Step S92).

Then, the subsystem 11S is restarted (Step S93).

After the restart, the subsystem 11S acquires time information and records the time required for completion of the application of the update patch files (Step S94).

The subsystem 11S checks the processing status of the main system 11M (Step S95).

Specifically, when the inquiry on the processing status of the main system 11M is made from the subsystem 11S, the bridge controller 14 inquires of the expansion board control microcomputer 17 about the standby states of the expansion boards (Step S96).

The expansion board control microcomputer 17 inquires of the expansion boards 19-1 to 19-6 about the standby states thereof (Step S97).

As a result, the network interface controllers (not illustrated) of the expansion boards 19-1 to 19-6 receive the inquiry and notify, as results of the inquiry, the expansion board control memory 20 of the standby states of the expansion boards 19-1 to 19-6 (Step S98).

The expansion board control memory 20 records the notified standby states of the expansion boards 19-1 to 19-6 (Step S99).

The expansion board control microcomputer 17 refers to the expansion board control memory 20 and notifies, as results of the reference, the subsystem 11S of the standby states of the expansion boards 19-1 to 19-6 through the bridge controller 14.

The subsystem 11S instructs, through the bridge controller 14, the expansion board control microcomputer 17 to release the pairing of the expansion boards in the standby state and the main system 11M (to separate the expansion boards in the standby state from the main system 11M) (Step S100), and pairs and reconnects those expansion boards in the standby state with the subsystem 11S (Step S101).

As a result, the task of the main system 11M is performed by the subsystem 11S (Step S102).

The subsystem 11S notifies the main system 11M of locations of the actually applied update patch files in the storage 13 (Step S103).

The main system 11M applies the update by using the update patch files actually applied to the subsystem 11S (Step S104).

After completing the application of the update, the main system 11M notifies the subsystem 11S of the completion of the update (Step S105).

The subsystem 11S instructs the expansion board control microcomputer 17 through the bridge controller 14 to release a pairing of the expansion boards in the standby state and the subsystem 11S (to separate the expansion boards in the standby state from the subsystem 11S), and pairs and reconnects the expansion boards in the standby state with the main system 11M (Step S106).

When all the expansion boards are reconnected to the main system 11M, the main system 11M starts the processing (Step S107), and the subsystem 11S stops the processing (Step S108).

After that, the subsystem 11S deletes the update patch files in the storage 13 and ends the processing (Step S109).

As described above, the updates can be securely applied by cooperation of the components of the information processing apparatus 10 while the normal operation of the information processing apparatus 10 continues. Therefore, except in a case of a stop caused by physical damage of a component, it is possible to systematically apply the update patches so as not to arise an overlap in timing of the processing with taking into account the schedule of tasks executed by a user. As a result, the sudden interruption of the normal operation due to action of the operating systems does not occur.

In other words, the information processing apparatus 10 can operate full-time while ensuring security of the information processing apparatus 10.

Accordingly, not only in the case of preventing a loss of data while continuous processing is performed as the normal processing, such as deep learning, machine learning, and scientific measurement, but also in office work, unintended interruption of work caused by the security patch application (update application) during a working time does not occur. In addition, an effective reduction in processing time and an effective reduction in labor time can be expected.

The disclosed technique is not limited to the embodiment described above, and can be carried out by being variously modified within the scope not deviating from the gist of the present embodiment. The configurations and the processes of the present embodiment can be selected as required, or may be combined as appropriate.

In the description above, the case has been described, in which the two systems of the main system 11M and the subsystem 11S are provided as systems that can be provided with the same operating system. Alternatively, three or more systems can be provided.

In the description above, the case has been described, in which the two operating systems of the main system 11M and the subsystem 11S are the same as each other. Alternatively, the operating systems may differ from each other as long as being capable of performing compatible operations.

In this case, although the systems can continuously operate, the subsystem cannot check the update patch files. Accordingly, a plurality of the main systems 11M and a plurality of the subsystems 115 are preferably provided, and in addition, a system for preliminarily checking the update patch files is preferably provided for each of the systems.

In the description above, the information processing apparatus 10 is exemplified by the personal computer. As a continuously operating information processing apparatus, such as a hard disk recorder for television video recording, a monitoring application for home security, and a smart speaker, the information processing apparatus 10 can effectively eliminate the trouble of maintenance and can be used full-time.

The disclosure described above allows persons skilled in the art to carry out and manufacture the present embodiment.

With regard to the embodiment described above, the following aspects are further described.

1. First other aspect

According to a first other aspect of the embodiment, an information processing apparatus includes: a plurality of control processing devices configured to be capable of performing control operations compatibly with each other; and a plurality of information processing devices configured to perform various types of information processing through an interface shared by the control processing devices under control of any of the control processing devices, wherein, before a first control processing device, which controls the information processing devices, is switched to a second control processing device among the plurality of control processing device, the second control processing device is configured as a copy of the first control processing device, and the information processing devices are sequentially switched to being under control of the second control processing device in a period where the information processing devices do not execute tasks constituting the information processing.

With the above-described configuration, even when any of the control processing devices is subjected to maintenance, it is possible to continue the processing by the second control processing device. Thus, even when a large amount of data is being processed, a highly safe, long-time operation can be performed while systematically performing the maintenance such as application of security patches.

2. Second other aspect

In the information processing apparatus according to a second other aspect of the embodiment, the plurality of control processing devices operate by a same operating system.

The above-described configuration can achieve full compatibility and achieve efficient maintenance that follows processing results of the maintenance (for example, whether the security patches have been applied) performed on any of the control processing devices.

3. Third other aspect

In the information processing apparatus according to a third other aspect of the embodiment, the switching between the first and second control processing devices is performed during update processing of the operating system, and the information processing apparatus further comprises a storage device configured to store update patch files used for the update processing and information on update patch files actually applied out of the update patch files when the second control processing device is updated after the second control processing device is configured as the copy of the first control processing device.

With the above-described configuration, it is possible to efficiently and safely perform the maintenance based on the information on the update patch files used for the update processing and based on the actually applied update patch files out of the update files that are stored in the storage device.

4. Fourth other aspect

In the information processing apparatus according to a fourth other aspect of the embodiment, the first control processing device performs, with reference to the storage device, the update processing using update patch files corresponding to the information on the update patch files actually applied.

With the above-described configuration, the update patch files, which are applied to the first control processing device, correspond to the actually applied update patch files. Therefore, the maintenance can be securely performed. 5. Fifth other aspect

In the information processing apparatus according to a fifth other aspect of the embodiment, one of the information processing devices, which controls the plurality of information processing devices through the interface, is specific one of the control processing devices.

The above-described configuration allows the specific one of the control processing devices to control all the information processing devices, and thus can effectively use the information processing devices.

6. Sixth other aspect

In the information processing apparatus according to a sixth other aspect of the embodiment, in a period where the information processing devices do not execute the tasks constituting the information processing after the update processing of the specific one of the control processing devices has been completed, the specific one of the control processing devices sequentially switches control on the information processing devices under the second control processing device to control on the information processing devices under the specific one of the control processing devices.

With the above-described configuration, it is possible to continue the processing without substantively affecting the processing of the task in each of the information processing devices during the switching between the control processing devices.

7. Seventh other aspect

In the information processing apparatus according to a seventh other aspect of the embodiment, the control processing devices comprise one or more central processing unit (CPU) cores that constitute a multi-core microprocessor.

With the above-described configuration, a single microprocessor can perform the highly safe, long-time operation while systematically performing the maintenance such as the application of the security patches.

8. Eighth other aspect

According to an eighth other aspect of the embodiment, a method implemented by a computer as an information processing apparatus comprising a plurality of control processing devices capable of performing control operations compatibly with each other and a plurality of information processing devices performing various types of information processing through an interface shared by the control processing devices under control of any of the control processing devices. The method includes: before a first control processing device, which controls the information processing devices, is switched to a second control processing device among the plurality of control processing device, configuring the second control processing device as a copy of the first control processing device; and sequentially switching the information processing devices to being under control of the second control processing device in a period where the information processing devices do not execute tasks constituting the information processing.

With the above-described configuration, even when any of the control processing devices is subjected to the maintenance, it is possible to continue the processing by the second control processing device. Thus, even when a large amount of data is being processed, the highly safe, long-time operation can be performed while systematically performing the maintenance such as the application of the security patches.

9. Ninth other aspect

According to a ninth other aspect of the embodiment, a computer program product including programmed instructions embodied in and stored on a non-transitory computer readable medium, the instructions being executed by a computer as an information processing apparatus comprising a plurality of control processing devices capable of performing control operations compatibly with each other and a plurality of information processing devices performing various types of information processing through an interface shared by the control processing devices under control of any of the control processing devices. The program instructs the computer to: before a first control processing device, which controls the information processing devices, is switched to a second control processing device among the plurality of control processing device, configure the second control processing device as a copy of the first control processing device; and sequentially switch the information processing devices to being under control of the second control processing device in a period where the information processing devices do not execute tasks constituting the information processing.

With the above-described configuration, even when any of the control processing device is subjected to the maintenance, it is possible to continue the processing by the second control processing device. Thus, even when a large amount of data is being processed, the highly safe long-time operation can be performed while systematically performing the maintenance such as the application of the security patches.

What is claimed is:

1. An information processing apparatus comprising:
a plurality of control processing devices that controls operations compatibly with each other; and
a plurality of information processing devices that performs various types of information processing through an interface shared by the control processing devices under control of any of the control processing devices, wherein,
before a first control processing device, which controls the information processing devices, is switched to a second control processing device among the plurality of control processing devices, the second control processing device is set as a copy of the first control processing device, and
the information processing devices are sequentially switched to be controlled by the second control processing device in a period where the information processing devices do not execute tasks constituting the information processing.

2. The information processing apparatus according to claim 1, wherein the plurality of control processing devices is operated by a same operating system.

3. The information processing apparatus according to claim 2, wherein
the switching between the first and second control processing devices is performed during update processing of the operating system, and
the information processing apparatus further comprises a storage device that stores update patch files used for the update processing and information on update patch files actually applied out of the update patch files when the second control processing device is updated after the second control processing device is set as the copy of the first control processing device.

4. The information processing apparatus according to claim 3, wherein the first control processing device performs, with reference to the storage device, the update processing using update patch files corresponding to the information on the update patch files actually applied.

5. The information processing apparatus according to claim 1, wherein one of the information processing devices, which controls the plurality of information processing devices through the interface, is a specific one of the control processing devices.

6. The information processing apparatus according to claim 5, wherein, in a period where the information processing devices do not execute the tasks constituting the information processing after the update processing of the specific one of the control processing devices has been completed, the specific one of the control processing devices sequentially switches control on the information processing devices under the second control processing device to control on the information processing devices under the specific one of the control processing devices.

7. The information processing apparatus according to claim 1, wherein the control processing devices comprise central processing unit (CPU) cores that constitute a multi-core microprocessor.

8. A method implemented by a computer as an information processing apparatus comprising a plurality of control processing devices that controls operations compatibly with each other and a plurality of information processing devices performing various types of information processing through an interface shared by the control processing devices under control of any of the control processing devices, the method comprising:
before a first control processing device, which controls the information processing devices, is switched to a second control processing device among the plurality of control processing devices, setting the second control processing device as a copy of the first control processing device; and
sequentially switching the information processing devices to be controlled by the second control processing device in a period where the information processing devices do not execute tasks constituting the information processing.

9. A computer program product including programmed instructions embodied therein and stored on a non-transitory computer readable medium, the instructions are executed by a computer as an information processing apparatus comprising a plurality of control processing devices that controls operations compatibly with each other and a plurality of information processing devices performing various types of information processing through an interface shared by the control processing devices under control of any of the control processing devices, the computer program instructing the computer to:
before a first control processing device, which controls the information processing devices, is switched to a second control processing device among the plurality of control processing devices, set the second control processing device as a copy of the first control processing device; and
sequentially switch the information processing devices to be controlled by the second control processing device in a period where the information processing devices do not execute tasks constituting the information processing.
